(19) United States
(12) Patent Application Publication
(10) Pub. No.: US 2010/0101408 A1
(43) Pub. Date: Apr. 29, 2010

(54) ROTARY ACTUATOR

(76) Inventor: Shawn Keel, Rock Hill, SC (US)

Correspondence Address: B. CRAIG KILLOUGH, P. O. DRAWER H, CHARLESTON, SC, 29402, US

(21) Appl. No.: 12/260,186

(22) Filed: Oct. 29, 2008

(51) Int. Cl. F15B 15/00; F15B 15/08; F16H 19/04; F16H 21/38

(52) U.S. Cl. 92/129; 92/136; 92/138; 74/109

(57) ABSTRACT

An actuator having one or more pistons. The piston has a rack formed in a skirt of the piston, with the rack recessed within the skirt of the piston in a groove formed between a top lip and a bottom lip. The gear, also called a pinion, engages the rack between the top lip and the bottom lip. As the rack traverses the gear, the shaft that extends through the gear is rotated. The top lip and bottom lip, and the recessed rack that is present within the skirt of the piston adds strength to the piston where the piston engages the gear. The top lip and the bottom lip assist in maintaining alignment of the rack with the gear so that the rack and gear properly mesh.

### FIELD OF THE INVENTION

This invention relates to fluid operated actuators.

### BACKGROUND OF THE INVENTION

Fluid operated actuators are used to operate and actuate valves and other controls. A fluid under pressure is used to create a rotational movement that opens and closes valves, or operates other control devices. The fluid may be a gas, including air, or a liquid, including hydraulic fluid.

The actuator may comprise a piston which provides linear travel of a rack. The rack engages a pinion or gear that is present on a shaft. The linear movement of the rack as the piston travels rotates the gear and the shaft to operate the valve or other control device. The rack and pinion actuator devices previously known are subject to breakage, and further, the piston or pistons are subject to undesired rotation within the cylinders, which has a negative effect on the alignment and engagement of the rack with the gear or pinion. There is a need for a piston and rack having superior strength. There is a need for a piston and rack structure that will retard binding and improve tracking of the piston and rack relative to the gear. There is a need for an actuator having increased torque relative to the size of the bore of cylinder.

### SUMMARY OF THE PRESENT INVENTION

The present invention is an actuator having one or more pistons. The piston has a rack formed in a skirt of the piston, with the rack recessed within the skirt of the piston between a top lip and a bottom lip. The gear, also called a pinion, engages the rack between the top lip and the bottom lip. As the rack traverses the gear, the shaft that extends through the gear is rotated. The top lip and bottom lip, and the recessed rack that is present within the skirt of the piston adds strength to the piston where the piston engages the gear. The top lip and the bottom lip assist in maintaining alignment of the rack with the gear so that the rack and gear properly mesh. The recessed rack permits the use of a larger gear relative to the size of the cylinder bore, which provides increased output torque.

### DESCRIPTION OF THE DRAWINGS

FIG. 1 is a perspective view of the actuator, showing the actuator body as a phantom.

FIG. 2 demonstrates applied fluid power acting upon the pistons in one direction.

FIG. 3 demonstrates applied fluid power acting upon the pistons in an opposite direction from that shown in FIG. 2.

FIG. 4 demonstrates movement of the pistons and rotation of the output shaft in a clockwise direction.

FIG. 5 demonstrates movement of the pistons and rotation of the output shaft in a counterclockwise direction.

FIG. 6 shows an isolation of a piston.

FIG. 7 shows an isolation of a piston and a gear.

FIG. 8 shows an isolation of a piston and a gear and shaft.

### DESCRIPTION OF THE PREFERRED EMBODIMENTS

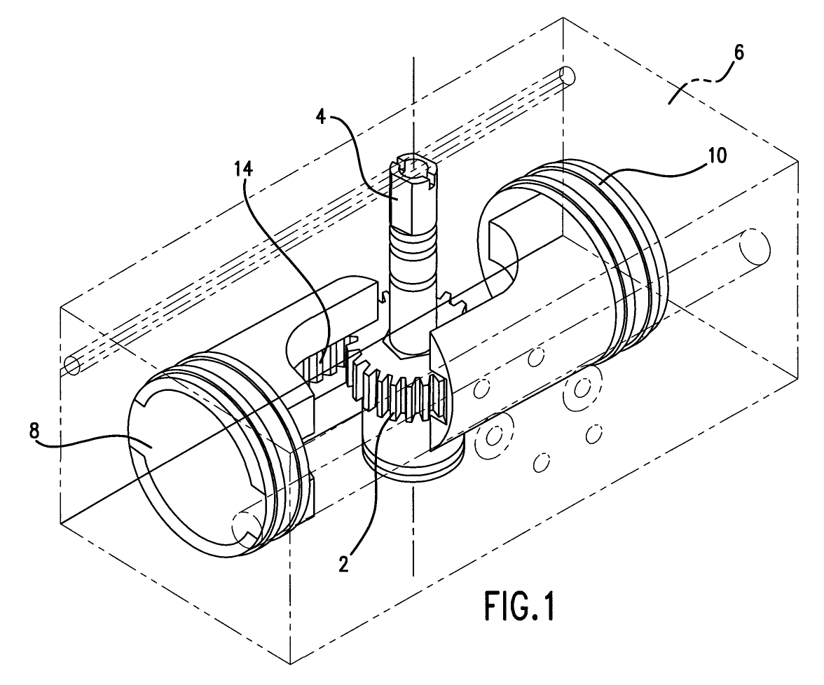

FIG. 1 shows a gear 2 or pinion that is present on an output shaft 4. At least one end of the output shaft extends to an exterior of the actuator body 6.

A first piston 8 and a second piston 10 are present in a cylinder 11 in the actuator body. The first piston and the second piston are in an opposed relationship with each other, and as shown in FIG. 1, are in a flat opposed relationship with each other. Each of said first piston and said second piston may have a crown and piston rings.

Each of said first piston and said second piston has a skirt 12. The skirt as shown in a preferred embodiment extends only along one side of the piston, and does not extend along the other side of the piston. The pistons of the actuator shown in FIG. 1 are identical to each other, but are rotated 180° from each other, and are opposed so as to move in an opposite direction from each other. The skirt of each piston has a rack 14 that is formed in a recessed groove within an interior of the skirt. The skirt has an upper lip 16 and a lower lip 18 that form the recess in which the groove is located. In a preferred embodiment, the teeth of the rack are located entirely within the recess, so that the upper lip and lower lip overhang the teeth, and no portion of the teeth extends beyond the upper lip or the lower lip in the direction that is toward the gear. In a preferred embodiment, the teeth of the gear that are currently engaging the rack are similarly entirely within the recess formed by the upper lip and lower lip.

As shown in FIG. 1, the rack of the first piston and the rack of the second piston engage the gear. The teeth of the gear are present within the groove formed by the upper lip and the lower lip. In the preferred embodiment, the teeth of the gear that engage the rack are within the groove or recess formed by upper lip and the lower lip, and are preferred to be entirely or substantially entirely present within the groove when engaging the rack. FIG. 7. The groove provides additional strength to the piston where the rack is present. Substantial force is transferred from the piston to the gear at this point. Further, the groove or recess retards the piston from rotating within the cylinder, providing for more precise and efficient meshing of the rack and gear, and better operation of the actuator.

The recessed rack allows the use of a larger diameter gear. The outside diameter of the gear, when measured from opposing sides of the teeth though the center of the gear, is preferred to be 60% or more of the diameter of the cylinder bore of the actuator body. The use of a larger diameter gear allows a gear ratio between the rack and gear that provides greater output torque relative to the size of the body of the actuator. In an application, such as turning a ball valve, that requires relatively high torque, but where space for mounting the actuator is limited, yielding higher torque relative to the bore size is of value. The length of the rack, and stroke of the pistons, may be increased in some applications due to the use of the larger diameter gear, and depending on the required degree of rotation of the shaft.

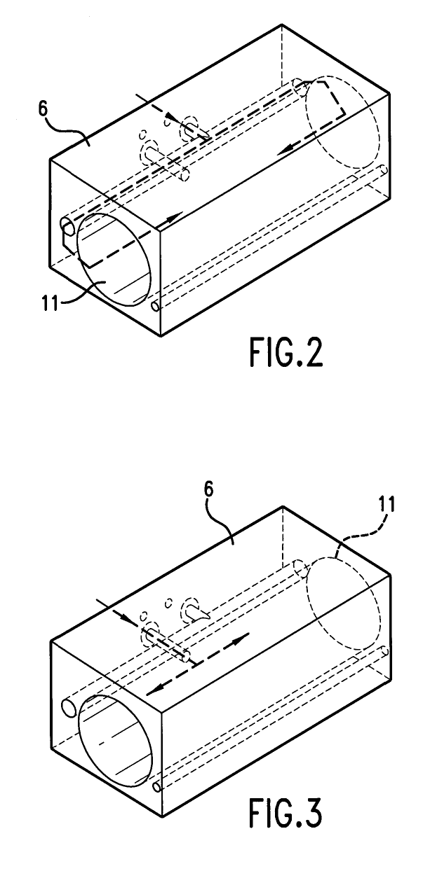

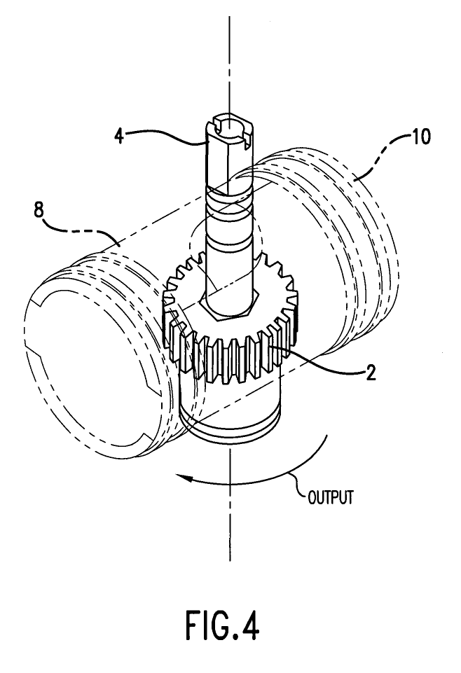

In use, a fluid under pressure is introduced through an inlet of the actuator body which acts to protect from the crown of the first piston and the crown of the second piston to push the pistons toward each other. FIG. 2 shows the flow of the fluid under pressure to act upon the top of the crowns of the pistons. FIG. 4 shows the first piston and the second piston as a phantom, having been pushed fully towards each other by the fluid flow of FIG. 2, and demonstrating that the rack of the first piston and the rack of the second piston have acted upon the gear to rotate the shaft in a clockwise direction.

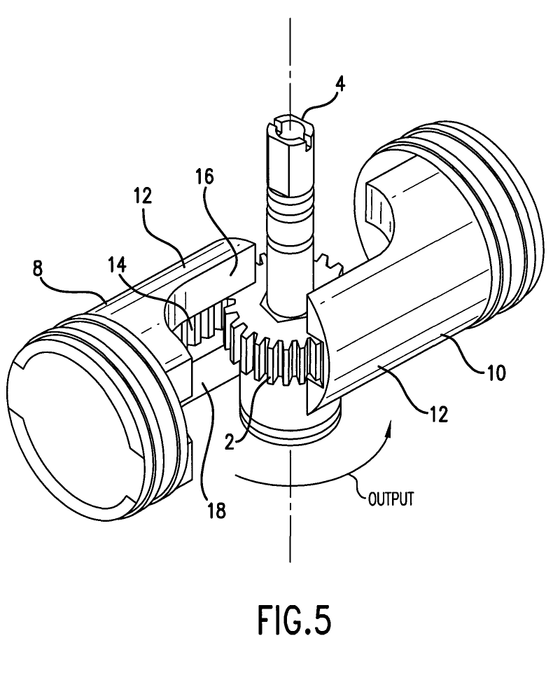

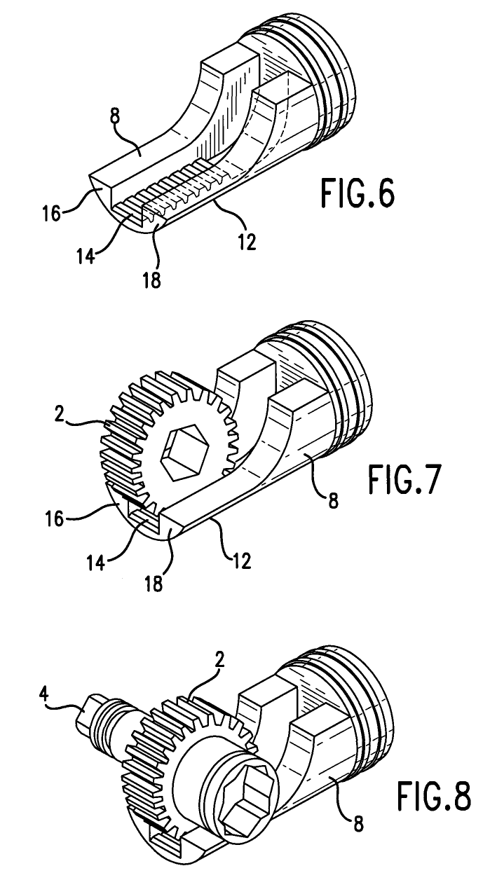

FIG. 3 shows a compressed fluid acting upon the first piston and the second piston in an opposite direction. FIG. 5 demonstrates the pistons having been pushed away from each other by the fluid flow of FIG. 3, with the rack of the first piston and the rack of the second piston engaging the gear and causing the output shaft to rotate in a counterclockwise direction.

The actuator may be pneumatically or hydraulically operated. Particular piston designs and actuator body designs may be adapted by those skilled in the art for pneumatic or hydraulic designs. The actuator may be designed to operate on compressed gas, including compressed air, or fluid under pressure, such as fluids used for hydraulic operations.

In use, the actuator may open and close valves such as gate valves and ball valves that are opened and closed by rotation of the valve. The actuator is particularly suitable for control of devices where a high degree of torque relative to a body size is desired, and is also used for applications where electrical actuators are hazardous or are not desired.

What is claimed is:

1. An actuator, comprising
a) a body;
b) a shaft comprising a gear;
c) a first piston, said first piston having a rack formed in a skirt of said first piston, wherein said rack is recessed within said skirt of said first piston between a top lip of said skirt of said first piston and a bottom lip of said skirt of said first piston, and wherein said gear engages said rack between said top lip of said skirt of said first piston and said bottom lip of said skirt of said first piston, and said first piston traverses said body and rotates said gear.

2. An actuator as described in claim 1, wherein said actuator further comprises a second piston, said second piston having a rack formed in a skirt of said second piston, wherein said rack is recessed within said skirt of said second piston between a top lip of said skirt of said second piston and a bottom lip of said skirt of said second piston, and wherein said gear engages said rack between said top lip of said skirt of said second piston and said bottom lip of said skirt of said second piston, and said second piston opposes said first piston and said second piston traverses said body in a direction opposite to said first piston and rotates said gear.

3. An actuator as described in claim 1, wherein a side of said first piston that is opposite said rack is open.

4. An actuator as described in claim 2, a side of said first piston that is opposite said rack is open and a side of said second piston that is opposite said rack is open.

5. An actuator as described in claim 1, wherein said top lip of said skirt of said first piston extends from said skirt of said first piston beyond said rack and said bottom lip of said skirt of said first piston extends from said skirt of said first piston beyond said rack and said rack is completely recessed within said skirt of said first piston.

6. An actuator as described in claim 2, wherein said top lip of said skirt of said first piston extends from said skirt of said first piston beyond said rack and said bottom lip of said skirt of said first piston extends from said skirt of said first piston beyond said rack and said rack is completely recessed within said skirt of said first piston, and wherein said top lip of said skirt of said second piston extends from said skirt of said second piston beyond said rack and said bottom lip of said skirt of said second piston extends from said skirt of said second piston beyond said rack and said rack is completely recessed within said skirt of said second piston.

7. An actuator as described in claim 1, wherein said first piston and said skirt of said first piston are formed as a unitary member.

8. An actuator as described in claim 2, wherein said first piston and said skirt of said first piston are formed as a unitary member, and wherein said second piston and said skirt of said second piston are formed as a unitary member.

9. An actuator as described in claim 1, wherein said first piston and said rack and said skirt of said first piston are formed as a unitary member.

10. An actuator as described in claim 2, wherein said second piston and said rack and said skirt of said second piston are formed as a unitary member and wherein said first piston and said rack and said skirt of said first piston are formed as a unitary member.

11. An actuator as described in claim 1, wherein said body has an inlet that communicates with said first piston and through which a pressurized fluid flows.

12. An actuator as described in claim 2, wherein said body has an inlet that communicates with said first piston and said second piston and through which a pressurized fluid flows.

13. An actuator as described in claim 1, wherein teeth of said gear, while engaging said rack of said first piston, extend completely between said top lip and said bottom lip of said skirt of said first piston.

14. An actuator as described in claim 2, wherein teeth of said gear, while engaging said rack of said first piston, extend completely between said top lip and said bottom lip of said skirt of said first piston and said teeth of said gear while engaging said rack of said bottom piston extend completely between said top lip and said bottom lip of said skirt of said second piston.

15. An actuator as described in claim 1, wherein said gear has an outside diameter that is at least 60% of the diameter of a cylinder bore of said body.

16. An actuator as described in claim 2, wherein said gear has an outside diameter that is at least 60% of the diameter of a cylinder bore of said body.
